(19) United States
(12) Patent Application Publication
(10) Pub. No.: US 2008/0051022 A1
(43) Pub. Date: Feb. 28, 2008

(54) Device for Ventilating a Vehicle

(75) Inventors: Wolfram Kuhnel, Stuttgart (DE); Volker Schramm, Ludwigsburg (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/578,075

(22) PCT Filed: Apr. 18, 2005
(86) PCT No.: PCT/EP05/04070

§ 371 Date: Nov. 16, 2006

(30) Foreign Application Priority Data
Apr. 19, 2004 (DE) 102004019440.8

(51) Int. Cl. B60H 1/34

(52) U.S. Cl. 454/152

(57) ABSTRACT

The invention relates to a device for ventilating a vehicle. Said device comprises a feed channel (1) and an outlet element (2) with an outlet opening (6) that defines an outlet plane of the air, whereby an air stream can he conducted through the feed channel (1) into an inlet (8) of the outlet element (2) and the air stream from the outlet element (2) emerges in the interior of the vehicle. The outlet element (2) comprises deflection means (3, 7a, 7b, 7c, 7d), which are used to generate spin in at least one section of the air stream. The aim of the invention is to provide a device with a mechanically simple construction, which does not require a large amount of installation space and which can deliver the most diffuse or non-directional air possible. To achieve this, the outlet plane is located essentially parallel to the direction (C) of the air stream in the vicinity of the inlet (8) of the outlet element.

The invention relates to a device for ventilating a vehicle as claimed in the preamble of claim 1.

DE 299 14 962 U1 describes an outlet of an interior space ventilating system for a motor vehicle in which an airstream which is fed through a feed duct can have an eddy applied to it by means of adjustable guide vanes, the airstream entering the interior space of the vehicle through an outlet opening which is essentially perpendicular to the feed duct. Such air outlets are provided essentially for mounting in the region of an instrument panel of the vehicle.

In modern motor vehicle engineering, the means for ventilating and air-conditioning the interior space are becoming increasingly more complex. In particular, it is desired to distribute the air at least optionally in such a way that a directional draught of air which is felt to be disruptive by the vehicle occupants is not produced. In addition, it is desired also to allow air to flow out selectively in rear or lateral vehicle regions or else roof regions in order to bring about distributed and possibly selectable ventilation. In this context, the limited installation space, in particular in the aforesaid regions, stands in the way of fulfilling the desire for air which flows out diffusely.

The object of the invention is to improve an air vent of the type mentioned at the beginning to the effect that a mechanically simple design and a small requirement for installation space can be achieved even for air which flows out diffusely, or in a way which is as nondirectional as possible.

This object is achieved according to the invention for an air vent of the type mentioned at the beginning by means of the characterizing features of claim 1.

The arrangement of the outlet face with an essentially parallel orientation with respect to the airstream which is supplied permits a particularly flat design in which nevertheless an airstream which is provided with an eddy and therefore emerges in a diffuse fashion is implemented. Eddy is understood here to be a rotation of the airstream which ultimately leads to the airstream leaving different areas of the outlet face in significantly different directions.

In one preferred embodiment of the device in accordance with the invention, the deflection means comprise a bent wall, in particular in the shape of part of a circle, of the outlet element, a height of the wall particularly preferably decreasing over the bent extent of the wall. This ensures in a simple and cost-effective fashion that the airstream emerges over the extent of the deflection means both in different directions and with a mass flow rate which remains as far as possible the same for each outlet face unit.

It is particularly preferred to provide a cover element, the outlet face extending between an outer edge of the cover element and an upper boundary of the wall. In this case, the outlet face preferably has the form of at least part of a circular ring, which permits an overall particularly controlled guidance of the airstream with simple means and in particular prevents a directional portion of the airstream from emerging, for example, from a central region of the outlet element.

In a further preferred embodiment, the deflection means comprise a multiplicity of walls which are parallel to one another, the airstream being guided at least between two of the walls. The length of the walls preferably differs here. This permits further improvement in the distribution of the uniform distribution of the airstream among different regions of the outlet face and thus in different directions.

An outlet element according to the invention is particularly preferably dimensioned in such a way that a maximum height of the outlet element which is measured perpendicularly to the outlet face does not significantly exceed a height of the feed duct. This permits an overall flat design of the device according to the invention.

It is advantageously possible to provide that a maximum diameter of the outlet element measured in the outlet plane is not significantly greater than twice a width of the feed duct. As a result, a device according to the invention can be used even when there is only a small installation space available.

In a further preferred embodiment of the device according to the invention, a multiplicity of outlet elements are connected to the feed duct. At least two outlet elements can advantageously be arranged essentially mirror-symmetrically with respect to one another on the feed duct, it being possible to distribute at least part of the airstream, essentially in halves, between the two outlet elements. Alternatively or additionally to this it is also possible to connect at least two outlet elements in succession to the feed duct in the direction of the airstream. This results overall in a high degree of flexibility when supplying diffuse ventilation to regions of a vehicle.

It is particularly preferably preferred that a device according to the invention has no elements which can be moved in an adjustable way for adjusting the deflection means in the normal driving mode of the vehicle. This permits a small and cost-effective design of the device according to the invention, and in particular the outlet element. It is therefore possible in particular for an outlet element according to the invention to be composed of just a small number of plastic components, in which case the fabrication from just a single plastic component using an injection molding method is also possible. In one preferred form, the outlet element is composed, during manufacture, from two components, specifically an element which comprises the deflection means and a lid which can be plugged on, and if appropriate bonded or clipped.

A device according to the invention is particularly preferably arranged in the region of an inner roof lining of a motor vehicle. Alternatively or additionally to this it can also be arranged in the region of a lateral roof column of a motor vehicle, on a passenger's seat or driver's seat, in the region of an instrument panel and/or in a rear interior space region of the vehicle. The device is particularly suitable for all these arrangements in a motor vehicle owing to its simple, space-saving and cost-effective design in conjunction with the properties of diffuse air distribution.

However, the device according to the invention can also be used in the region of an instrument panel of the vehicle, in which case it can complement or replace conventional ventilation devices.

Further advantages and features of a device according to the invention emerge from the exemplary embodiments and from the dependent claims.

Three preferred exemplary embodiments of a device according to the invention are described below and explained in more detail with reference to the appended drawings, in which:

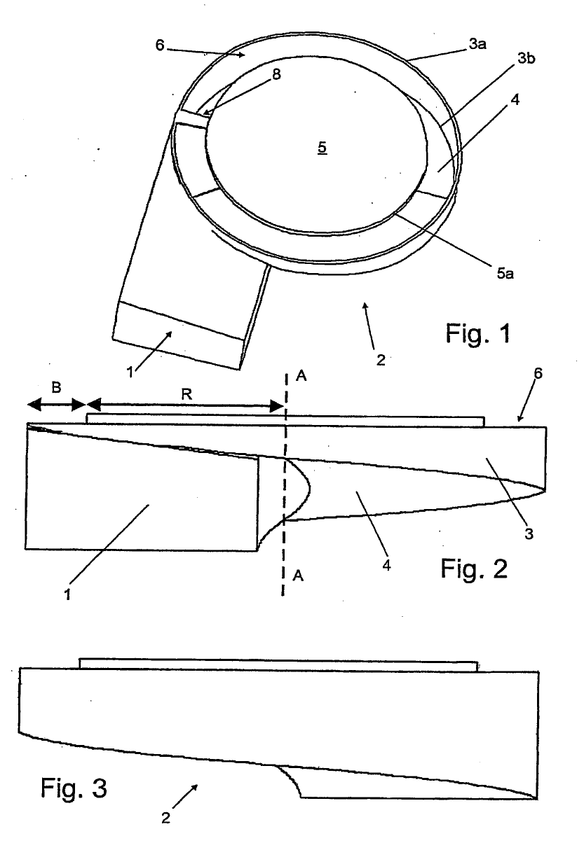

FIG. 1 shows a spatial view of a first embodiment of a device according to the invention,

FIG. 2 shows a plan view of the device from FIG. 1 in the direction of the feed duct,

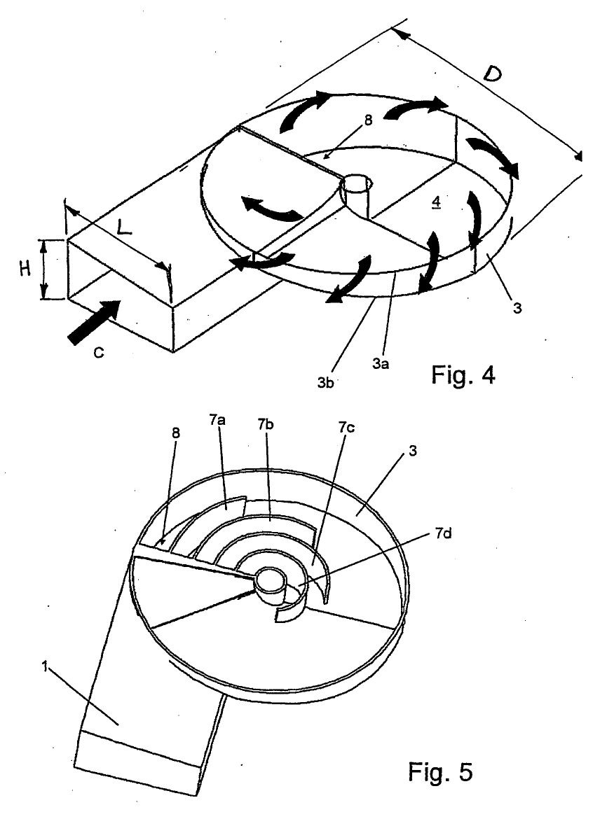

FIG. 3 shows an end plan view of the device from FIG. 1,

FIG. 4 shows a partial spatial illustration of the device from FIG. 1, in which directions of flow of the air in various regions of the device are indicated,

FIG. 5 shows a spatial view of a second preferred embodiment of a device according to the invention, and

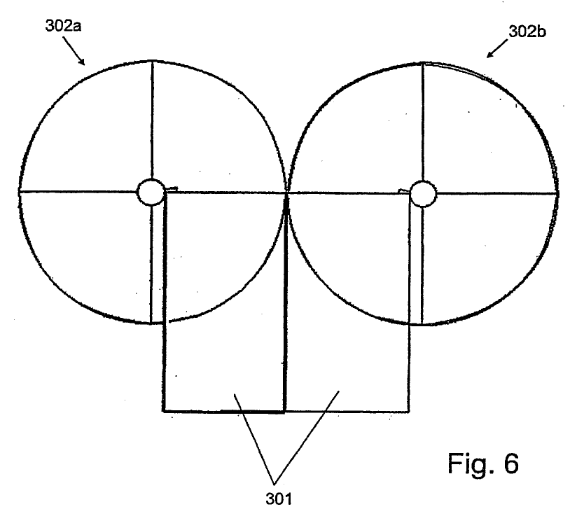

FIG. 6 shows a schematic illustration of a plan view of a third preferred embodiment of a device according to the invention.

The first embodiment according to FIG. 1 comprises an essentially straight feed duct 1 which has a trapezoidal cross section here (see in particular FIG. 2).

The feed duct 1 is adjoined in the direction of flow of the air by an outlet element 2. The outlet element 2 comprises a bent wall 3, in particular in the shape of part of a circle, which starts at an inlet region 8 of the outlet element 2. An upper terminating boundary 3a of the wall extends essentially in a plane which is referred to the outlet plane. The bent wall 3 forms a deflection means for the air which flows in the outlet element 2.

A lower terminating boundary 3b of the wall does not extend in a plane but rather forms a spiral around a central axis A of the outlet element (see FIG. 2).

As a result, the height of the wall 3 is not constant over its bent extent. In each case the distance from the lower terminating boundary 3b which is perpendicular to the upper terminating boundary 3a is defined as a height of the wall 3 for a given point on the upper terminating boundary 3a of the wall.

A base 4 of the outlet element 2 covers an underside of the outlet element 2 completely and terminates with the extent of the lower terminating boundary 3b. The base 4 is therefore not planar but rather constitutes a spiral surface corresponding to the profile of the lower terminating boundary 3b.

An essentially circular lid 5 is arranged in the outlet plane, a centre point of the lid lying on the central axis A. The lid has a smaller radius R than the constant distance from the centre axis A to the upper terminating boundary 3a of the outlet element 2. As a result, an essentially circular-ring-shaped open outlet face 6 with a constant width B remains between an edge 5a of the lid 5 and the upper terminating boundary 3a of the wall 3. The ratio of the width B to the radius R of the lid 5 is approximately 1:3.2 in the present exemplary embodiment. Depending on the required profile for the flowing out of air this ratio can be adapted by selecting a larger or smaller lid 5.

The illustration according to FIG. 4 shows the outlet element 2 without the lid 5. FIG. 4 shows the direction of the air respectively flowing out at various points on the outlet face 6. It is clear that the air is provided with an eddy through the guidance or deflection along the bent wall 3. The air therefore emerges at different locations on the outlet face in different directions. In addition, viewed on a local basis, the air also emerges with a vortex, which is indicated by the bend of the arrows in FIG. 4.

Overall, this ensures that the air emerges in a particularly diffuse and nondirectional fashion.

The decrease in the height of the wall 3 over its circumference contributes significantly to the fact that an approximately constant outlet stream of air is ensured over the extent of the outlet face 6 since due to the space which tapers in the circumferential direction the local air pressure in the outlet element is increased dynamically to the same extent as it is lowered by the previously emitted air.

A direction C of the airstream in the region of the inlet 8 of the outlet element 2 is clear in particular from FIG. 4 and extends parallel to the walls of the feed duct 1 in this region. This direction C is essentially parallel to the outlet plane in which the outlet face 6 is located. In the present exemplary embodiment, the diameter D of the outlet element 2 is approximately 80 mm and the width of the feed duct 1 is approximately 40 mm. The maximum height H of the feed duct 1 is 20 mm. These numerical values are to be understood only by way of example. For outlet elements 2 which are particularly flat in design it is possible to reduce the height H of the feed duct 1 further, for example to 10 mm.

It is made clear that it is not absolutely necessary to taper the height of the wall. A similar effect of uniform distribution of the air can be achieved, for example, by means of an outlet face which widens over its circumference, which can be achieved, for example, by means of a lid which differs from the circular shape.

Likewise, the outlet face 6 does not need to lie exactly in one plane. Embodiments in which the upper circumferential wall extends in a spiral shape are also conceivable. In the sense of the invention, this still defines an outlet plane. It is important that said plane is arranged essentially parallel to the direction C of the airstream in the inlet region 8 of the outlet element 2 so that a flat and space-saving design of the device according to the invention is ensured. Depending on the shape of the available installation space, the feed duct 1 can here also be bent just before its entry into the outlet element 2.

The plan view according to FIG. 2 shows that a maximum diameter of the outlet element 2 which is measured in the outlet plane is not significantly greater than twice the width of the feed duct 1, which is here the distance between the two parallel walls of the feed duct 1.

In addition, a maximum height (measured in the direction of the center axis A) of the outlet element 2 is not significantly greater than a maximum height of the feed duct 1 which corresponds to the height of the longer of the two parallel duct walls. In terms of order of magnitude, the value of the maximum height is approximately 10 to 30 mm, in particular 20 mm.

The second exemplary embodiment of the device according to the invention according to FIG. 5 differs from the first exemplary embodiment in that additional deflection means 7a, 7b, 7c, 7d are provided. These deflection means each comprise walls which are concentric with respect to the center axis A, extend parallel to the outer wall 3 and taper correspondingly in their height over their extent. The walls 7a, 7b, 7c, 7d each start, like the outer wall 3, at the inlet 8 of the outlet element 2 but have different lengths. In particular, the innermost wall 7d follows the circular extent of the airstream in the outlet element 2 over the largest circular angle and the outer additional wall 7a extends over the smallest circular angle. The second exemplary embodiment also comprises a lid 5, which is however not shown in FIG. 5 for the sake of better illustration.

The second exemplary embodiment achieves overall an even further improved uniform distribution of the emerging airstream over the extent of the outlet face. In addition, the air has an even greater eddy applied to it so that particularly diffuse flowing out of the air into the interior space of the vehicle is achieved.

A third preferred exemplary embodiment of a device according to the invention is illustrated in FIG. 6. Here, two outlet elements 302a, 302b which each correspond to one of the exemplary embodiments above are arranged mirror-symmetrically with respect to one another. In each case, approximately half of an airstream from a particularly wide feed duct 301 enters each of the outlet elements 302a, 302b.

Such a parallel arrangement of a plurality of outlet elements according to the invention permits even relatively large airstreams to be distributed in a simple way and by means of standardized components. Alternatively or in addition to the third exemplary embodiment, outlet elements 2 can also be arranged in succession on the same (main) feed duct (not illustrated). Overall, the previously described outlet elements therefore permit a diffuse distribution of large air flow rates which can both be used in a flexible way and saves installation space.

In conclusion it is to be noted that all of the devices according to the invention described above have the further advantage that very little noise is generated by the airstream even with large air flow rates. This is due to the fact that the application of a vortex or eddy to the air is carried out uniformly over a large area and there are no large local differences in air pressure or flow rate at any location on the outlet elements 2.

1. A device for ventilating a vehicle, comprising a feed duct and an outlet element having an outlet opening which defines an outlet plane of the air, it being possible to conduct an airstream through the feed duct into an inlet of the outlet element, and the airstream from the outlet element entering an interior space of the vehicle, and
the outlet element having a deflection means by means of which an eddy can be supplied to at least part of the airstream, wherein the outlet plane is arranged essentially parallel to a direction (C) of the airstream in the region of the inlet of the outlet element.

2. The device as claimed in claim 1, wherein the deflection means comprise a bent wall, in particular in the shape of part of a circle of the outlet element.

3. The device as claimed in claim 2, wherein a height of the wall decreases over the extent of the bent wall.

4. The device as claimed in claim 2 wherein the outlet element has a cover element, the outlet face extending between an outer edge of the cover element and an upper boundary of the wall.

5. The device as claimed in claim 2, wherein the outlet face has the form of at least part of a circular ring.

6. The device as claimed in claim 2, wherein the deflection means comprise a multiplicity of walls which are parallel to one another, the airstream being guided at least between two of the walls.

7. The device as claimed in claim 6, wherein the walls have various lengths.

8. The device as claimed in claim 1, wherein a maximum height of the outlet element which is measured perpendicularly to the outlet face does not significantly exceed a height of the feed duct.

9. The device as claimed in claim 1, wherein a maximum diameter of the outlet element measured in the outlet plane is not significantly greater than twice a width of the feed duct.

10. The device as claimed in claim 1, wherein a multiplicity of outlet elements is connected to the feed duct.

11. The device as claimed in claim 10, wherein at least two outlet elements are arranged essentially mirror-symmetrically with respect to one another on the feed duct, it being possible to distribute at least part of the airstream, essentially in halves, between the two outlet elements.

12. The device as claimed in claim 10, wherein at least two outlet elements are connected in succession to the feed duct in the direction of the airstream.

13. The device as claimed in claim 1, wherein no elements which can be moved in an adjustable way for adjusting the deflection means in the normal driving mode of the vehicle are provided on the device.

14. The device as claimed in claim 1, wherein the device is arranged in the region of an inner roof lining of a motor vehicle.

15. The device as claimed in claim 1, wherein the device is arranged in the region of a lateral roof column of a motor vehicle.

16. The device as claimed in claim 1, wherein the device is arranged on a passenger's seat or driver's seat of a motor vehicle.

17. The device as claimed in claim 1, wherein the device is arranged in a rear interior space region of a motor vehicle.

18. The device as claimed in claim 1, wherein the device is arranged in the region of an instrument panel of a motor vehicle.
